(19) United States
(12) Patent Application Publication
(10) Pub. No.: US 2007/0088679 A1
(43) Pub. Date: Apr. 19, 2007

(54) Method and apparatus for facilitating shareholder claims compensation

(76) Inventor: Brad Heffler, Conshohocken, PA (US)

Correspondence Address: REED SMITH, LLP, TWO EMBARCADERO CENTER, SUITE 2000, SAN FRANCISCO, CA, 94111, US

(21) Appl. No.: 11/251,318

(22) Filed: Oct. 14, 2005

(51) Int. Cl. G06F 17/30

(52) U.S. Cl. 707/3

(57) ABSTRACT

A database is prepared having entries for a plurality of claims that are pending or settled in the class action industry. A query technique, that is applied individually or part of a monitoring program, determines outstanding claims available (settled) or pending with relation to individual stocks or a selected portfolio. Results of the query are returned in a user friendly format that allows access to claims information and other details. Data from the query is utilized to prepare user selected reports having the most relevant information needed by shareholders to determine appropriate courses of action to collect or respond to action(s) for each case. Results of the query are forwarded to other sub-systems that help advise and/or prepare forms for the filing of claims for a particular case. Institutional investors are provided the ability to prepare a watch list and/or future case list such that any claims activity is tracked and provided in an efficient useable format.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to case monitoring and the production of case related documents. The present invention is more particularly related to case monitoring and the filing of claims related to the monitored cases. The invention is yet more particularly related to the monitoring of class action lawsuits that have either settled or been awarded on behalf of shareholders, for either individual or a portfolio of investment holdings, and the provision of information and analysis needed to prepare claims by or on behalf of shareholders.

2. Discussion of Background

The class-action lawsuit is a way for investors to recoup losses from corporate misdeeds or other irregularities of the corporations in which they have invested. Over the last several years, there have been an unprecedented number of corporate wrongdoings including massive fraud. WorldCom, Enron, analyst's conflicts, excessive stock options, IPO laddering suits, arrests of corporate officers, and the list goes on and on. Investors, now skeptical of large corporations and their executives, are facing the reality that their life savings disappeared in a matter of months.

Following in the footsteps of these highly publicized corporate debacles were the inevitable class action lawsuits. These suits have often been characterized as frivolous by those that have been targets. However, it is time that investors recognize the value of these suits in recovering a portion of their lost funds.

Over the past five years, class action recoveries have helped put approximately $10 billion back into the hands of investors. Previously, institutional investors, including hedge funds, mutual funds and pension funds, have looked at these cases with disdain. The pervasive perception was that filing a claim involved a tremendous amount of work in gathering and copying old trading records in addition to deciphering the complexities of the claim filing process. In addition, these same investors held the view that potential recoveries were miniscule and not worth the time and effort of the laborious claim filing process.

This perception is beginning to change due to an interesting combination of occurrences. The primary factor is the increased size of the average class action settlement during this period. Besides the large increase in the average settlement, the magical billion dollar threshold was exceeded in two settlements, Cendant Corporation Litigation and the Nasdaq Market-Makers Antitrust Litigation. In addition, the acceptance of electronic filing methods by certain claims administrators has reduced the amount of paperwork involved in the claim filing process.

What is needed is for various institutional investors to take a fresh look at class actions. With the market's decline, shareholders are looking for ways to cut expenses and increase returns. If an institutional shareholder decides to undertake the potentially steep learning curve in the claims filing process, he also needs to be diligent about tracking class action filings and settlements. Class action recoveries have the potential to provide a much needed shot in the arm on the income side without incurring a significant increase in expenses.

### SUMMARY OF THE INVENTION

The present inventor has realized the need to provide institutional and individual shareholders an efficient method for diligently tracking class action lawsuits and presenting key relevant information needed to prepare and file appropriate claims against the class action verdict or settlement.

In one embodiment, the present invention provides a method of claims compensation, comprising the steps of, preparing a database of information for each of a plurality of class action cases pending and/or settled against a set of companies, querying the database and retrieving results of the query, and displaying the results of the query.

In another embodiment, the present invention is a method of administering a Claims Compensation business, comprising the steps of, registering a set of users, receiving a watch list from each user, periodically querying a claims database, comparing case results from the query to each user's watch list, and notifying a user if any of the case results comprise either new cases or settled cases matching any part of the user's watch list.

Portions of both the invention may be conveniently implemented in programming on a general purpose computer, or networked computers, and the results may be displayed on an output device connected to any of the general purpose, networked computers, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s), etc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a screen shot of an example main page according to an embodiment of the present invention;

FIG. 2A is an example of Case Search Screen 200 according to an embodiment of the present invention;

FIG. 2B is an example of a Case Reports Screen 250 according to an embodiment of the present invention;

FIG. 2C is an example of a Case Details Screen 280 according to an embodiment of the present invention;

FIG. 3 is a screen shot of an example undistributed cases report according to an embodiment of the present invention;

FIG. 4 is a screen shot of an example detailed case information page according to an embodiment of the present invention;

FIG. 5 is a screen shot of an example profile gathering page according to an embodiment of the present invention'

FIG. 6A is a screen shot of an example watch list according to an embodiment of the present invention;

FIG. 6B is a screen shot of an example future case list according to an embodiment of the present invention;

FIGS. 7A and 7B are flow charts of an example user process and interactions with a Case Monitoring System according to an embodiment of the present invention; and

FIGS. 8A and 8B are flow charts of a process in a Case Monitoring System according to an embodiment of the present invention.

### DESCRIPTION OF THE PREFERRED EMBODIMENTS

The present invention provides a system for monitoring cases, particularly class actions and SEC restitution funds, and provides important data to investors, fund managers, or anyone with an interest in the cases being monitored. In the case of publicly traded stocks, securities, or other instruments, the monitoring and data are particularly important to stock brokers, proprietary trading firms, mutual funds, hedge funds, trust companies, market makers & specialists, news organizations, individual investors, trust companies, investment managers, endowment funds, and like.

In the week of Jan. 10, 2005, over 40 mutual funds were sued by shareholders for allegedly failing to file class action claims in order to recover settlement money to which the funds' shareholders were entitled. Some of the funds included in the suit may have filed their claims but many probably did not. Mutual funds may have a fiduciary duty to file class action claims. However, if the Courts do find that mutual funds breached their duty to the funds' shareholders, the funds could be subjected to substantial liability.

In the past, many mutual funds concluded that the work in tracking numerous cases, compiling voluminous data and filing the claims was not worth the amount of potential recoveries. The rash of large cases such as Worldcom, Lucent and Enron along with hundreds of other settlements has created several billion dollars in settlement funds. This increase in potential recoveries combined with the fear of being subjected to lawsuits for non-filing should compel mutual funds and every other type of fund, trust company or investment manager which may have a fiduciary duty to reexamine their claim filing policies.

Claims Compensation Bureau (“CCB”) has been filing class action claims for their institutional client base since 1996. CCB offers comprehensive class action services to the mutual fund industry. Please contact us for additional information about both our ongoing claims filing services as well as our retroactive claims services.

Claims Compensation Bureau, Inc. (CCB) was the first firm in the country to monitor and file class action claims on behalf of institutional and individual investors. The present invention is a new and novel method to help track and file claims. The present invention utilizes, for example, data provided by a client user to provide information needed to file appropriate claims. The present invention takes advantage of the technical understanding from experience in monitoring, researching, preparing and filing securities class action claims to provide a system that is automated and indicates needed information in a fast and easy to use user interface that allows the client user to quickly identify and fulfill requirements of a class action verdict, settlement, or other award to which a claim is to be filed.

In one embodiment, the present invention monitors all class action settlements to ensure that every claim is filed on behalf of the user clients. The present invention, for example, includes data found through detailed searching of old case documents, provides information and data needed to prepare the necessary claim forms, and helps verify that the amount received in all class actions is accurate.

In one embodiment, the present invention is a case monitoring system which is a web based tool that assists shareholders in the monitoring and filing of their class action claim forms. The system uses a custom program which allows users to query a case database created and updated by CCB or other host server implementing the invention.

The database contains several data points which are critical to the accurate filing of a class action claim form. Most of these data points are contained in a legal document called a Notice of Class Action Settlement (“Notice”). In addition, to capturing the pertinent data points, the Plan of Allocation section of the Notice is analyzed in order to capture additional information which is added to the database. This additional information can be utilized in the decision of whether or not to file a claim form in addition to aiding the shareholder in the filing of an accurate and complete claim form. Further research is performed to capture data such as stock splits, stock symbols and company mergers which may not be readily available in the Notice. This type of information is added to the database in order to further assist in the claim filing process.

Multiple sources are utilized in order to ensure that all Notices are captured in the database. All data added to the monitoring database is verified multiple times to ensure accuracy.

The following is a detailed description of how an end-user can use the monitoring system to research the database in order to ensure that all claim forms are filed:

I. Setting up Monitoring System Client Profile:

1. Choose Client Profile to add or change Contact or Account information.
   a) Add or change Contact Information, such as name, email address, street address, city, state, country, zip code, or phone number.
   b) Add or change log-in password.
   c) Add or change Email Update preference, choosing one of the following options: Monthly Summary; as new cases are added; both of above; No emails.
2. For any additions or changes to take effect, the user must select the Submit Changes button before getting out of the Client Profile view.
   II. Creating Reports
1. Once on the Monitor Home Page, the client may choose one of the following Key Reports.
a) Undistributed Cases: This report will give, in table format, all active cases where the settlement funds have not been distributed. For each company, the stock symbol, class period, settlement fund, and filing deadline are listed. These are the most important at-a-glance criteria, readily indicating whether deeper insight into the case is necessary. In effect, these cases are all open to filing, even if the filing deadline has passed. A client would choose this report to get the most comprehensive listing of cases to match to their current and past portfolio. For new clients, this would be the most useful Key Report, due to its comprehensiveness.
b) New Cases: This report lists those cases that have settled in the last 30 days which have claim forms available and those cases which may have settled earlier which claim forms recently became available. This report is formatted identically to the one above. Users would access the New Cases report as an ongoing (perhaps weekly) check to make certain the newest cases are properly compared to their current and past portfolio. This report is most useful after the more comprehensive Undistributed Cases report has been carefully evaluated shortly after beginning use of the monitoring system.
c) Pending Cases: This report lists those cases that are pending settlement but have not yet settled in addition to settled cases which do not yet have claims forms available. Once settled, these cases would move to the New Cases report. This report is formatted identically to the two above. Like the New Cases report, users would access this report on an ongoing basis. It would give them advance notice of cases that should be settling shortly or which should have claim forms to fill out shortly. Unlike those cases in the New Cases report, ones in the Pending Cases report may often not have all case information available.
2. If a Key Report is not desired, a user may create a customized report using the Case Search function. Once in the Case Search view, a user may define the criteria of cases being looked for in one or more of the ten case criteria fields. The format for resulting Case Search reports are identical as those for the Key Reports described above. The 10 Case Search fields are as follows:
a) Company Name: By filling in all or part of a company name, those companies with that name will appear. It is best if a user only fills in the first 3-5 letters of the company desired. While this may yield more “hits” than desired, it greatly lessens the chances of misspelling causing a false “no match” result.
b) Stock Symbol: This field may be completed if looking for a case or cases related to a particular stock symbol. A partial string of letters will bring up all cases with that string anywhere within the symbol. Where the accurate name or spelling of a company may be unknown, sometimes a stock symbol may be a better way to search for cases.
c) Opt-Out/Exclusion Deadline: This field would be filled in by a user looking for cases where the opt-out/exclusion date was before, after, or between a certain date or dates. Use of this field for searching cases would most likely be for those users interested in opting-out of one or more cases.
d) Beginning of Class Period: This field would be filled in by a user looking for cases where the beginning of the class period was before, after, or between a certain date or dates. Use of this field for searching cases would be helpful for isolating cases before or after a certain date.
e) End of Class Period: This field would be filled in by a user looking for cases where the end of the class period was before, after, or between a certain date or dates. Use of this field for searching cases would be helpful for isolating cases before or after a certain date.
f) Filing Deadline: This field would be filled in by a user looking for cases where the filing deadline was before, after, or between a certain date or dates. This field would primarily be used by users to isolate those cases where filing deadline have or have not expired.
g) Settlement Fund: This field is filled in by a user looking for cases where the settlement fund is below, at, or above a certain dollar amount. In most cases, a user would complete this field as part of a search to find those cases with settlements over or under a predetermined amount.
h) Claims Administrator: This field has a list of 20+ claims administrators. It may only be completed using the drop down list. A user may choose to search using this field to determine which cases a particular administrator was associated with.
i) CUSIP Number(s): One or more CUSIP numbers may be entered in this field (separated by commas) to identify the corresponding case(s) for those securities with those CUSIP numbers. To identify possible claims opportunities, some users would conduct a case search by CUSIP number, rather than company name or stock symbol.
j) Case Status: There are four dropdown options for this field: Any Status, Settled, Distributed, and Pending. By choosing ‘Settled,’ a user will create a report identical to the ‘Undistributed’ Key Report. This lists all cases which are settled with funds that have not been distributed. By choosing ‘Distributed,’ a user creates a report for all cases where fund have been distributed and thus, there is no chance for filing a late claim. If a user selects ‘Pending,’ a report is created for all cases that have not yet settled and/or there is no claim form yet available for the case.
3. Once all search criteria has been entered, the ‘Submit Form’ button must be clicked. It is important to note that multiple fields may be used in doing case searches. The more fields that are used, the more the resulting report will be focused. If no cases are found from the search, a new search can be done, changing the search parameters appropriately.
   III. Manipulating and Using Reports
1. Once a report has been generated, either a Key Report or through the Case Search function, it can be manipulated in a variety of ways to best serve the user. Clicking on the column heading for any of the six report columns will toggle between an ascending and descending sort of the that column's information. Quickly sorting this information within the monitoring system will allow users to do the following.
a) View alphabetical list of companies.
b) View alphabetical list of symbols.
c) Find the earliest date of class period beginnings. This will be useful in determining how far back to obtain trading records.
d) Find the latest date of class period endings. This will be useful in determining the latest date necessary for obtaining trading records.
e) Find the largest and smallest settlement funds. This is very useful to users in their efforts to prioritize their claim filing activity.
f) Find the closest and most distant filing deadline dates. This is also very useful to users in their efforts to prioritize their claim filing activity.
2. Reports generated in the monitoring system can also be copied or exported to an Excel or Word document for more extensive manipulation. In doing this, customized comparisons can be made between cases (companies) on the report and user holdings.
   IV. Examining Case Details
1. Once a report is generated within the monitoring system, any case (company) on the report may be examined more closely. Clicking on a particular company will bring up the Detailed Case Information page for that case. In addition to the information provided on the report view, the Detailed Case Information page gives the following Key Case Information: Opt-Out/Exclusion Deadline, CUSIP Numbers, Case Status, and Claim Administrator.
2. An important and unique section of the Detailed Case Information page is the Important Claim Filing Information section. Within this section, a variety of useful case information may be presented. Since every case has its own idiosyncrasies, the amount of information in this section will vary from case to case. The important information contained within this section includes the following.
   a) Options: A user is informed if the case involves options. In approximately 25% of cases, all of the option trading information is used to calculate a recognized loss. For users who trade options, this information is necessary to know, so option trading records are obtained in addition to those of the common stock.
   b) Option Premium: For a small percentage of cases that do not involve all of the option trading information, the calculation of a recognized loss requires information on the option premiums paid and/or received if options were purchased and/or sold during the class period. As in ‘a’ above, option traders need to know this information in order to gather the necessary option information.
   c) Stock Split Information: A user is informed if one or more stock splits occurred during the class period, and given the ratio of each split. If one or more stock splits occurred during a class period, that information must be known in order to properly calculate a claim. Failing to incorporate stock split information in the calculation of a claim is a common obstacle area in cases where one or more splits have occurred.
   d) Supplemental Settlement: An additional settlement, after the original settlement, was reached. In some of these supplemental settlements a new claim form and release must be signed in order to receive the additional funds. Informing users of supplemental settlements assures them of not missing funds they are due.
   e) Multiple Sub-Periods: There are multiple sub-periods within the class period, which may have different formulas for calculating the claim. Often, when there are multiple sub-periods, each sub-period has a different formula applied to its trading. Providing this information to users gives them a sense as to how complex the plan of allocation for the case may be.
   f) LIFO (Last-in-first-out): In almost all cases, FIFO (first-in-first-out) accounting is used to calculate claims. In rare instances, LIFO is used. Highlighting this for users makes certain they realize it when calculating their claim.
   g) Table: There are one or more tables involved in calculating the claim. Users are informed that they would need to refer to one or more tables in the plan of allocation.
   h) Gains are Ignored: In the calculation of the claim, gains are ignored. In the great majority of cases, gains offset losses in claim calculations. In approximately 5% of cases, gains are ignored and do not offset losses. When gains are ignored, recognized losses will increase, all things being equal. In fact, when gains are ignored, an overall gain could still produce a recognized loss. This key piece of information alerts users to file a claim even if an overall gain may have been recognized during the class period.
   i) Option Recovery Limited: The total recovery for call and put options will not exceed a certain percentage of the net settlement fund. Users are alerted to this limit on their recovery for option losses.
   j) Short Sales not Included: Short sales during the period are not recognized in calculating the claim. In addition, no recognized loss will be computed for losses on purchases to cover short sales. Alerting users that these transactions are not included insures accurate claim calculations and can assist the user in deciding whether or not a claim needs to be filed.
   k) Miscellaneous Case Information: Many cases have specific nuances that do not fall into any of the above categories. When this information is useful in calculating the claim and/or understanding the case in general, it is entered as an additional point in the Important Claim Filing Information section. Without having to sift through the detail of the claim notice, users are able to learn of key miscellaneous information related to the case.
3. The last part of the Detailed Case Information page is a section for Important Case Documents. In this section links are provided to one or more of the following three PDF documents.
   a) Settlement Notice: Quick access to the settlement notice gives users everything they need to know about the case and calculating the claim. Rather than going to multiple websites or contacting multiple administrators, settlement notices for each settled case are in one place, CCB's monitoring system.
   b) Proof of Claim: Quick access to the proof of claim for settled cases gives users the form they need to file their own claim. Rather than going to multiple websites or contacting multiple administrators, proof of claims for each settled case are in one place, CCB's monitoring system.
   c) Notice of Pendency: Quick access, for pending cases, to the notice of pendency, giving users somewhat detailed information on pending cases. Rather than going to multiple websites or contacting multiple administrators, notices of pendency for pending cases are in one place, CCB's monitoring system.
      V. Watch List
1. To create an easy to find list of those cases a user may want to access multiple times, a Watch List can be created. On the bottom of any Detailed Case Information page, there is an ‘Add to My Watch List’ button. Clicking this button adds that case to the user's watch list. In addition, multiple cases may be added to the watch list from any report created by the user by, for example, clicking on one or more of the check boxes on the right hand side of a report.
2. The Watch List can be accessed from the Case Monitor home page by selecting the ‘Watch List’ link. This view will list all companies to be watched along with a box to select removal from this list.

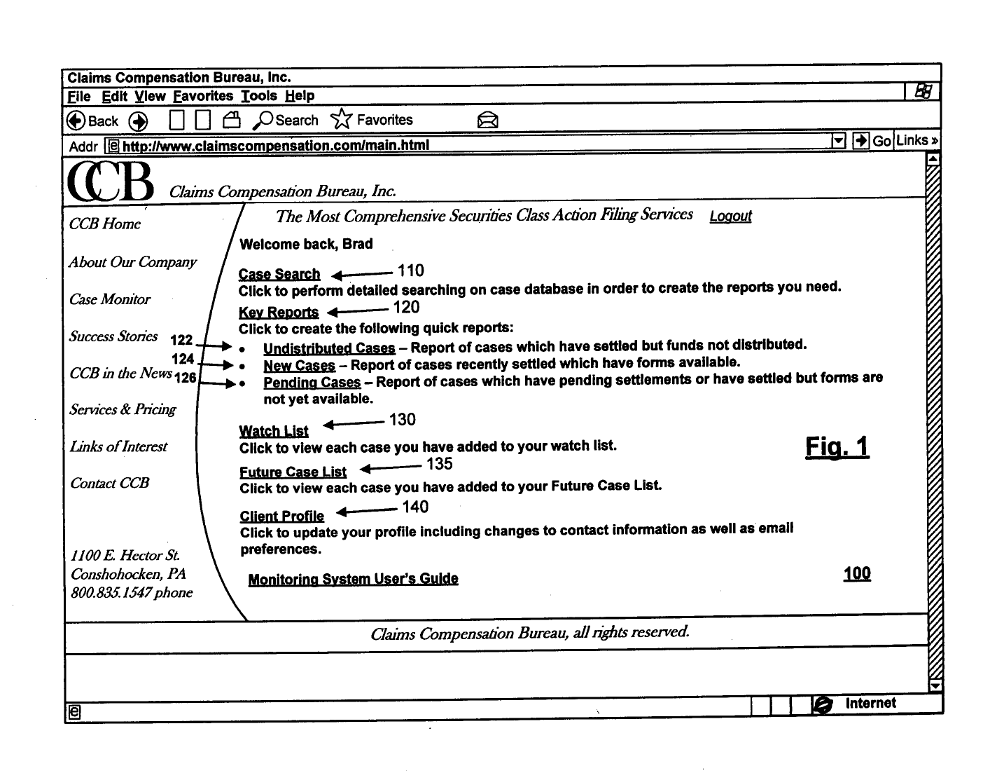

Referring now to the drawings, wherein like reference numerals designate identical or corresponding parts, and more particularly to FIG. 1 thereof, there is a screen shot of an example main page 100 according to an embodiment of the present invention. The main page is, for example, a web page constructed for, for example, HTML, JAVA code, and other programming hosted on a server connected to and having an address on the Internet or other network (e.g., public or private). The present invention includes, for example, various product areas usable by a client user of the main page 100, including a link to a Case Search 110, links to various key reports (e.g., Undistributed Cases 122, New Cases 124, and Pending Cases 126), a link to a Watch List 130, a link to a Future Cases List 135, and a link to Client Profile 140. The data retrieved or pointed to by each of the links may alternatively be accessed via pull down menus, buttons, or other links accessible via the main page 100 or other web pages. As shown in FIG. 1, the links include verbiage, instructions, and/or other information in close proximity to each of the links.

The present invention includes a claims database which includes, for example, stock symbols, company names, and relevant information related to claims and/or filing of claims. The database is, for example, a relational database.

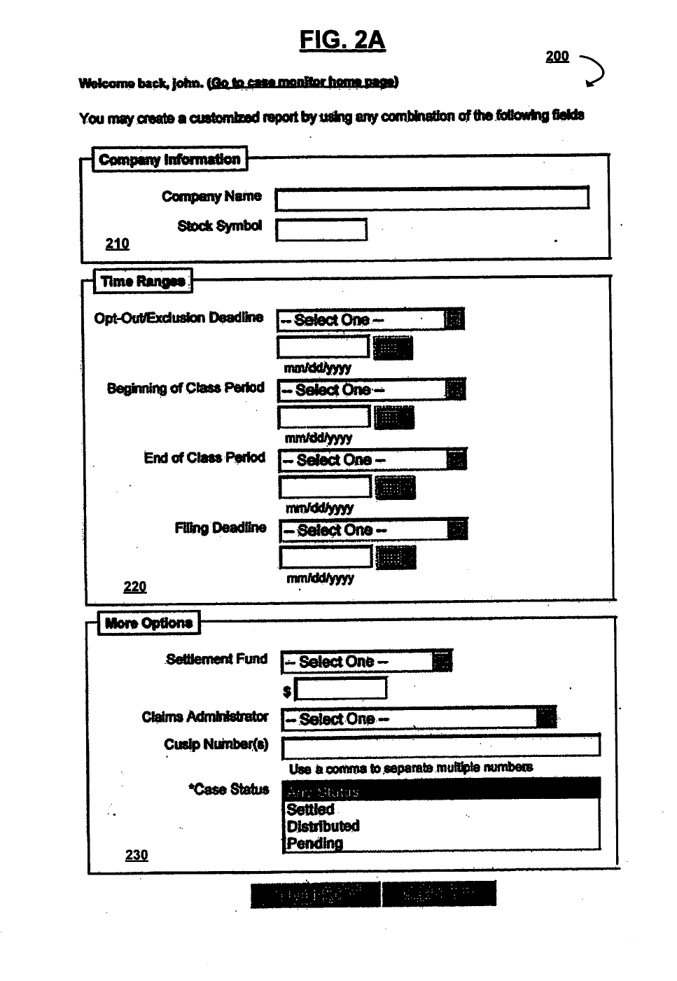

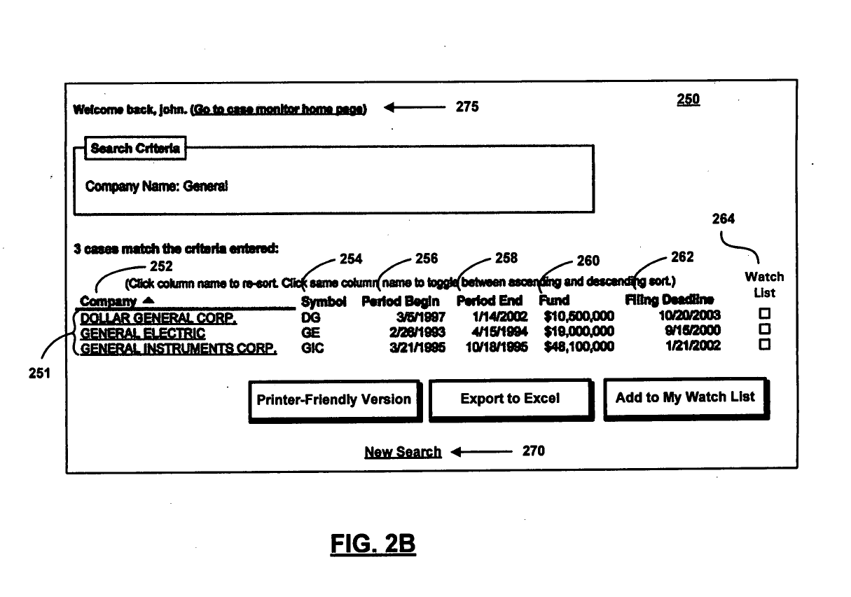

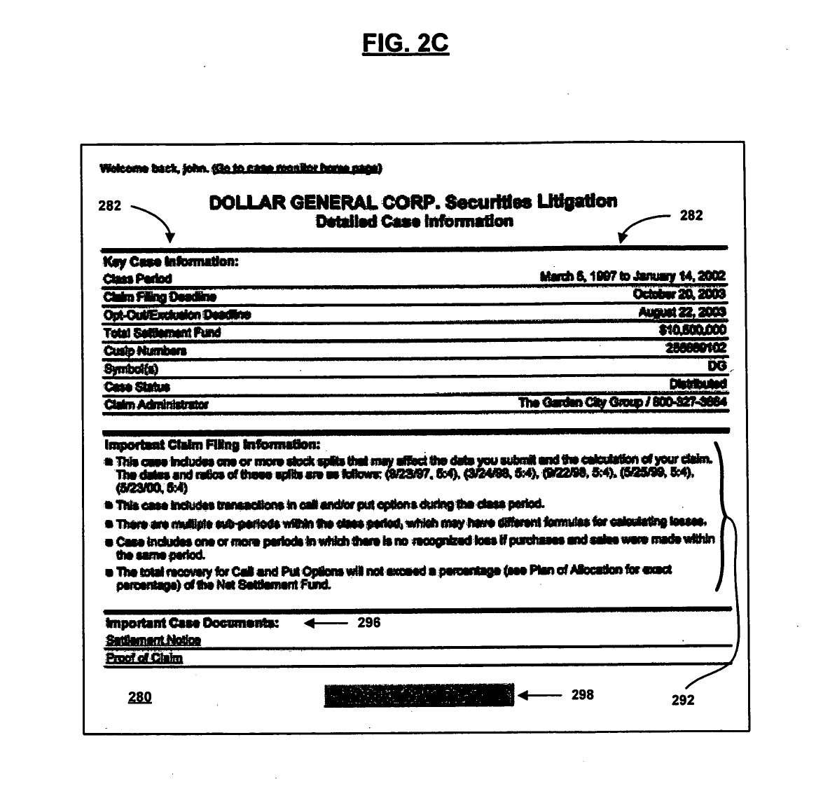

FIG. 2A is an example of Case Search Screen 200 according to an embodiment of the present invention. The case search Screen 200 is invoked by activating the Case Search link 110. The Case Search Screen 200 includes various options for conducting a search of the claims database, including, for example, company information 210 (e.g., company name, stock symbol, etc.), Time ranges 220 that are used to specify recent or older cases (e.g., Opt-Out/Exclusion deadline, Class period, filing deadline, etc.), and other (more options 230) that are criteria to identify claim or otherwise further restrict a search (e.g., Settlement Fund greater than or less than a specific amount, Administrator, Status, etc.).

FIG. 2B is an example of a Case Reports Screen 250 according to an embodiment of the present invention. In this example, a case search using the company criteria was performed with a company name of “General.” In this example, the results (rows 251) indicate three companies whose names have “General” in them having actions in the claim database. The information displayed is, for example, a portion of the data maintained in the claims database for each of the hits, including Company name 252, Symbol 254, Period Begin 256 Period End 258, Fund 260, and Filing Deadline 262. The portion of data displayed may vary depending on the specifics of the implementation. As with all of the preferred search or result listings according to the present invention, the tabular column of the listing may be “clicked” on to re-sort based on that column and place the results in ascending or descending order (e.g., first click on column sorts each row in ascending order based on the “clicked” column value of that row, and a second click resorts the same in descending order). Conveniently located links are provided to perform a new search 270 and return to the case monitor main page 275 so that a different type of search or other tasks may be performed.

FIG. 2C is an example of a Case Details Screen 280 according to an embodiment of the present invention. The Case Details Screen 280 provides all major details of a selected case. In this example, Dollar General Corp was selected (“clicked” on) from the Case Search Result Screen 250. The Case Details include Key Case information 282 such as the Class period, Claim Filing Deadline, Opt-Out/Exclusion Deadline, Total Settlement Fund, CUSIP Numbers, Symbol(s), Case Status, and Claims Administrator. The Key Case Information 282 is information that is generally present in each case, but is specific to the selected case (Dollar General Corp., in this example).

The Case Details further includes, for example, Important Claim Filing Information 292. The Important Claim Filing Information 292 is information that may or may not be present in any given case, and the appearance of each of the listed bullet items in 292 is predicated based on information about the class action. For example, the first bullet item includes information about stock splits, and will only be included in cases where stock splits are relevant to a claim being filed for the case being detailed. In this example, the splits are identified because they potentially accept data that needs to be submitted in a claim, and the stock splits themselves are identified by date and stock split ratio (e.g., Sep. 23, 1997, 5:4; Mar. 24, 1998, 5:4, etc.). The Important Claim Filing Information 292 is based, for example, on the Settlement notice, plan of allocation, or other data available about the case. These documents are analyzed in order to capture critical data that helps in the decision of whether or not to file a claim as well as what data is necessary to file a claim. Some of the information in the important claim filing section, such as stock splits, may not be available in any case documents, but is gathered through research (e.g. Internet, stock publications, etc.).

The Case Details yet further includes, for example, Important Case Documents 296. The Case Documents are, for example, the Settlement Notice, and a Proof of Claim. The Settlement Notice is a legal document that describes all the details and technical information about the action and claim filing. Significant experience in reading and analyzing Settlement Notices is required in order to make a sound judgment on the effect of any one or more clause or portions of the Settlement Notice. The present invention includes the review of individual case Settlement Notices and the plan of allocation for the case by experienced reviewers that provide the important information derived from such plans and notices into the Claims database where it is then used to provide the Important Claims Information 292. The proof of Claim is a court approved form needed for filing a valid claim.

A conveniently located “Add to My Watch List” Button 298 is provided in direct conjunction with the Case Details to add the Case being reviewed to the user's watch list. The watch list is a list of one or more companies, institutions, stocks, bonds, or other instruments that the user has a particular interest and on which the user receives updates when any action occurs. Updates are, for example, sent via email to a user when an action settles or other significant activity. In one embodiment, an email alert is sent to a client user as reminder of an approaching deadline (e.g., approaching claim filing deadline), and the user can add to a preferences file the timing of reminders (e.g., one month, one week) for each of one or more selected different types of deadlines or other items which reminders can be helpful.

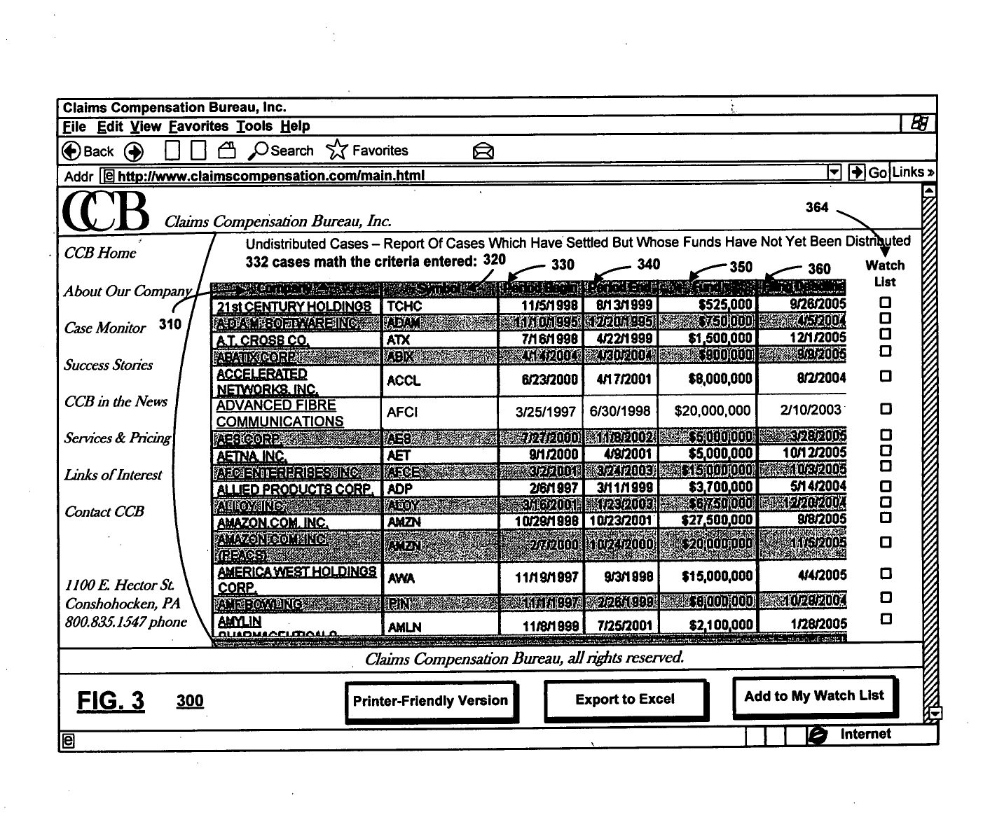

FIG. 3 is a screen shot of an example undistributed cases report 300 according to an embodiment of the present invention. The undistributed cases report is invoked, for example, via activation of the undistributed cases link 122 under the key reports section of main page 100. The undistributed cases report 300 is a report of cases which have settled but whose funds have not been distributed. Data for the report 300 is pulled from the database of cases and displayed, for example, in the illustrated format, including Company name 310, Symbol (e.g. Stock Symbol) 320, Period Begin 330, Period End 340, Fund 350, and filing deadline 360. In this example, 332 undistributed cases are reported and additional pages (not shown) may be scrolled and/or paged down by the user to review all of the data.

An exemplary case is:

| 310 | 320 | 330 | 340 | 350 | 360 |
|---|---|---|---|---|---|
| Advanced Fibre | AFCI | Mar. 25, 1997 | Jun. 30, 1998 | 20,000,000 | Feb. 10, 2003 |
| Communications | | | | | |

indicating a filing deadline of Feb. 10, 2003 to apply for a share of a 20 million dollar fund available to stockholders who purchased Advanced Fibre Communications (AFCI) between Mar. 25, 1997 and Jun. 30, 1998.

Whether provided in response to a specific query such as that described in FIGS. 2A and 2B or to a more general query as in the above described undistributed case report (FIG. 3), a database query is built and applied to the database of the cases to retrieve and then display the necessary information. In the case of the specific query, data retrieved from the fields or text boxes of FIG. 2A are used to build the query. In the case of the more general, quick link type queries, standard information related to the quick link is saved as a pre-existing query that is utilized upon invocation of the corresponding link.

Table 1 is an example of a query structure according to an embodiment of the present invention for building the queries.

TABLE 1

```
<cfquery name=“qryCases” datasource=“#attributes.ds#”>
    SELECT
        CaseID,
        Company,
        Symbol,
        BegClass,
        EndClass,
        Fund,
        Deadline,
        Admin,
        CusipNumber1,
        Administrator,
        ActiveFlag
    FROM Cases a WITH (NOLOCK)
    LEFT OUTER JOIN Administrator b WITH (NOLOCK)
    ON a.Admin = b.Code
    WHERE <cfif
FindNoCase(“\admin\”,CGI.CF_Template_Path)>1=1<cfelse>A
ctiveFlag = ‘Y’</cfif>
            <cfif
Len(Trim(attributes.search_company))>
                AND Company LIKE
‘%#attributes.search_company#%’
            </cfif>
            <cfif
Len(Trim(attributes.search_symbol))>
                AND Symbol LIKE
‘%#attributes.search_symbol#%’
            </cfif>
            <cfif
Len(Trim(attributes.search_deadline))>
                <cfif
attributes.search_deadline EQ “Later Than” AND
IsDate(Trim(attributes.search_deadline1))>
                    AND ExclusionDeadline >=
#CreateODBCDate(Trim(attributes.search_deadline1))#
                <cfelseif
attributes.search_deadline EQ “Earlier Than” AND
IsDate(Trim(attributes.search_deadline1))>
                    AND ExclusionDeadline <=
#CreateODBCDate(Trim(attributes.search_deadline1))#
                <cfelseif
attributes.search_deadline EQ “Between” AND
IsDate(Trim(attributes.search_deadline1)) AND
IsDate(Trim(attributes.search_deadline2))>
                    AND ExclusionDeadline >=
#CreateODBCDate(Trim(attributes.search_deadline1))# AND
ExclusionDeadline <=
#CreateODBCDate(Trim(attributes.search_deadline2))#
                </cfif>
            </cfif>
            <cfif
Len(Trim(attributes.search_periodStart))>
                <cfif
attributes.search_periodStart EQ “Later Than” AND
IsDate(Trim(attributes.search_periodStart1))>
                    AND BegClass >=
#CreateODBCDate(Trim(attributes.search_PeriodStart1))#
                <cfelseif
attributes.search_periodStart EQ “Earlier Than” AND
IsDate(Trim(attributes.search_periodStart1))>
                    AND BegClass <=
#CreateODBCDate(Trim(attributes.search_periodStart1))#
                <cfelseif
attributes.search_periodStart EQ “Between” AND
IsDate(Trim(attributes.search_periodStart1)) AND
IsDate(Trim(attributes.search_periodStart2))>
                    AND BegClass >=
#CreateODBCDate(Trim(attributes.search_periodStart1))#
AND BegClass <=
#CreateODBCDate(Trim(attributes.search_periodStart2))#
                </cfif>
            </cfif>
            <cfif
Len(Trim(attributes.search_periodEnd))>
                <cfif
attributes.search_periodEnd EQ “Later Than” AND
IsDate(Trim(attributes.search_periodEnd1))>
                    AND EndClass >=
#CreateODBCDate(Trim(attributes.search_periodEnd1))#
                <cfelseif
attributes.search_periodEnd EQ “Earlier Than” AND
IsDate(Trim(attributes.search_periodEnd1))>
                    AND EndClass <=
#CreateODBCDate(Trim(attributes.search_periodEnd1))#
                <cfelseif
attributes.search_periodEnd EQ “Between” AND
IsDate(Trim(attributes.search_periodEnd1)) AND
IsDate(Trim(attributes.search_periodEnd2))>
                    AND EndClass >=
#CreateODBCDate(Trim(attributes.search_periodEnd1))#
AND EndClass <=
#CreateODBCDate(Trim(attributes.search_periodEnd2))#
                </cfif>
            </cfif>
            <cfif
Len(Trim(attributes.search_filingDeadline))>
                <cfif
attributes.search_filingDeadline EQ “Later Than” AND
IsDate(Trim(attributes.search_filingDeadline1))>
                    AND Deadline >=
#CreateODBCDate(Trim(attributes.search_filingDeadline1)
)#
                <cfelseif
attributes.search_filingDeadline EQ “Earlier Than” AND
IsDate(Trim(attributes.search_filingDeadline1))>
                    AND Deadline <=
#CreateODBCDate(Trim(attributes.search_filingDeadline1)
)#
                <cfelseif
attributes.search_filingDeadline EQ “Between” AND
IsDate(Trim(attributes.search_filingDeadline1)) AND
IsDate(Trim(attributes.search_filingDeadline2))>
                    AND Deadline >=
#CreateODBCDate(Trim(attributes.search_filingDeadline1)
)# AND Deadline <=
#CreateODBCDate(Trim(attributes.search_filingDeadline2)
)#
                </cfif>
            </cfif>
            <cfif
Len(Trim(attributes.search_fund))>
                <cfif attributes.search_fund EQ
“More Than” AND
IsNumeric(Trim(attributes.search_fund1))>
                    AND Fund >=
#Trim(attributes.search_fund1)#
                <cfelseif
attributes.search_fund EQ “Less Than” AND
IsNumeric(Trim(attributes.search_fund1))>
                    AND Fund <=
#Trim(attributes.search_fund1)#
                <cfelseif
attributes.search_fund EQ “Between” AND
IsNumeric(Trim(attributes.search_fund1)) AND
IsNumeric(Trim(attributes.search_fund2))>
                    AND Fund >=
#Trim(attributes.search_fund1)# AND Fund <=
#Trim(attributes.search_fund2)#
                </cfif>
            </cfif>
            <cfif
Len(Trim(attributes.search_admin))>
                AND Admin =
‘#attributes.search_admin#’
            </cfif>
            <cfif
Len(Trim(attributes.search_cusip))>
                AND
                (
                    <CFLOOP FROM=“1”
TO=“#evaluate(listlen(attributes.search_cusip)−1)#”
INDEX=“thisListItem”>
                        CusipNumber1 =
‘#Trim(listgetat(attributes.search_cusip,
thisListItem))#’ OR
                        CusipNumber2 =
‘#Trim(listgetat(attributes.search_cusip,
thisListItem))#’ OR
                        CusipNumber3 =
‘#Trim(listgetat(attributes.search_cusip,
thisListItem))#’ OR
                    </CFLOOP>
                    CusipNumber1 =
‘#Trim(listlast(attributes.search_cusip))#’ OR
                    CusipNumber2 =
‘#Trim(listlast(attributes.search_cusip))#’ OR
                    CusipNumber3 =
‘#Trim(listlast(attributes.search_cusip))#’
                )
            </cfif>
            <cfif
Len(Trim(attributes.search_status))>
                AND
                (
                    <CFLOOP FROM=“1”
TO=“#evaluate(listlen(attributes.search_status)−1)#”
INDEX=“thisListItem”>
                        ClaimStatus =
‘#listgetat(attributes.search_status, thisListItem)#’
OR
                    </CFLOOP>
                    ClaimStatus =
‘#listlast(attributes.search_status)#’
                )
            </cfif>
            <cfif
Len(Trim(attributes.search_keywords))>
                AND ( Company LIKE
‘%#attributes.search_keywords#%’ OR Comments LIKE
‘%#attributes.search_keywords#%’ )
            </cfif>
            <cfif
Len(Trim(attributes.search_reportdate))>
                AND ReportDate >=
#CreateODBCDate(Trim(attributes.search_reportdate))#
            </cfif>
    ORDER BY #attributes.orderBy#
</cfquery>
```

Table 1 illustrates a query structure that accepts the search criteria entered, looks through the Cases and Administrator tables, and returns matching cases (admin reports use this same query—essentially they are canned case searches with built-in criteria). The search criteria is a series of criteria that, for example, may be provided by a user through a GUI (e.g., FIG. 2A). The criteria is utilized in the illustrated SELECT statement of Table 1. Table 1 further illustrates the cases database and other details that relate to a specific embodiment of a query based on the criteria. And finally, significant formatting is provided to display the retrieved information, fitting it to an appropriate report.

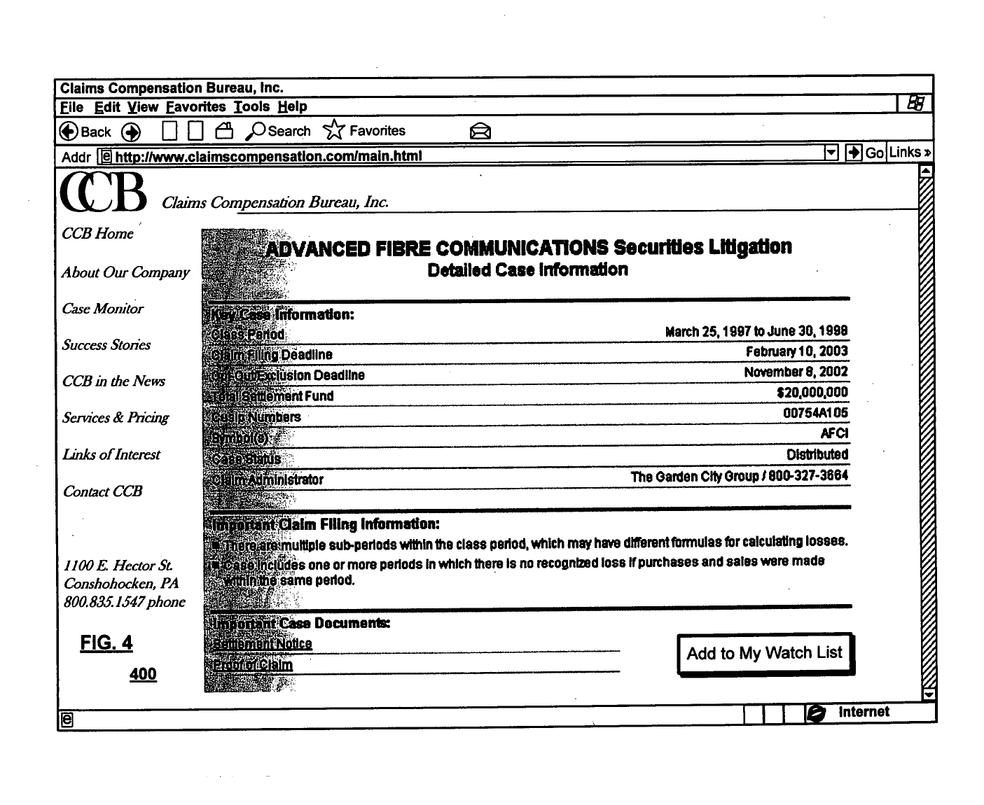

As shown in FIG. 3, a convenient link to the detailed case information is provided, via hyperlink to each company name. FIG. 4 is an example screen shot of detailed case information 400 for AFCI displayed on a web page according to an embodiment of the present invention. The detailed case information 400 is formatted, for example, to include Key Case Information, Important Claim Filing Information, and Important Case Documents, similar to that described in FIG. 2C. The detailed case information is, for example, a comprehensive listing of data related to the selected case that has been retrieved from the case database. Table 2 provides an example coding that displays detailed case information retrieved from the case database.

```
TABLE 2
<!--- Claim filing info --->
<cfif Len(Trim(GetDetails.TrailingPeriod)) OR
Len(Trim(GetDetails.StockSplits)) OR
Len(Trim(GetDetails.Comments))
      OR Len(Trim(GetDetails.Options)) OR
Len(Trim(GetDetails.OptionPrem)) OR
Len(Trim(GetDetails.SettlementSecurities))
      OR Len(Trim(GetDetails.Code))>
    <table width=“100%” cellpadding=“2”
cellspacing=“0” border=“0”>
        <tr><td width=“1%”>&nbsp;</td><td
width=“99%”>&nbsp;</tr>
        <tr>
            <td colspan=“2”
class=“SectionHeader”><strong>Important Claim Filing
Information:</strong></td>
        </tr>
    <cfif Len(Trim(GetDetails.TrailingPeriod))>
        <tr>
            <td valign=“top”><img
src=“/images/bullet.gif” alt=“” width=“7” height=“7”
border=“0” vspace=“4”></td>
            <td>This case includes a trailing
sales period of #Replace(GetDetails.TrailingPeriod,“−
”,“ − ”)#. Even though these dates are outside of the
class period, the trade information for sales made in
this period needs to be submitted.</td>
        </tr>
    </cfif>
    <cfif Len(Trim(GetDetails.StockSplits))>
        <tr>
            <td valign=“top”><img
src=“/images/bullet.gif” alt=“” width=“7” height=“7”
border=“0” vspace=“4”></td>
            <td>This case includes one or more
stock splits that may affect the data you submit and
the calculation of your claim. The dates and ratios of
these splits are as follows:
#GetDetails.StockSplits#</td>
        </tr>
    </cfif>
    <cfif Len(Trim(GetDetails.Comments))>
        <tr>
            <td valign=“top”><img
src=“/images/bullet.gif” alt=“” width=“7” height=“7”
border=“0” vspace=“4”></td>
            <td>This case includes other claim
filing considerations that may affect the data you are
required to submit or the calculation of your claim as
follows: #GetDetails.Comments#</td>
        </tr>
    </cfif>
    <cfif Len(Trim(GetDetails.Options))>
        <tr>
            <td valign=“top”><img
src=“/images/bullet.gif” alt=“” width=“7” height=“7”
border=“0” vspace=“4”></td>
            <td>This case includes transactions
in call and/or put options during the class
period.</td>
        </tr>
    </cfif>
    <cfif Len(Trim(GetDetails.OptionPrem))>
        <tr>
            <td valign=“top”><img
src=“/images/bullet.gif” alt=“” width=“7” height=“7”
border=“0” vspace=“4”></td>
            <td>The plan of allocation requires
the option premium to be incorporated into the price of
any stock that was purchased or sold due to the
exercise of an option.</td>
        </tr>
    </cfif>
    <cfif Len(Trim(GetDetails.SettlementSecurities))>
        <tr>
            <td valign=“top”><img
src=“/images/bullet.gif” alt=“” width=“7” height=“7”
border=“0” vspace=“4”></td>
            <td>The amount of the total
settlement fund includes an estimated value for
securities included in the settlement. This value will
fluctuate with the market price of the securities.</td>
        </tr>
    </cfif>
    <cfif Len(Trim(GetDetails.Code))>
        <cfloop
query=“application.ClaimFilingTipRef”>
            <cfif
ListFind(GetDetails.Code,application.ClaimFilingTipRef.
ClaimFilingTipID)>
                <tr>
                    <td valign=“top”><img
src=“/images/bullet.gif” alt=“” width=“7” height=“7”
border=“0” vspace=“4”></td>
    <td>#application.ClaimFilingTipRef.ClaimFilingTip
Text#</td>
                </tr>
            </cfif>
        </cfloop>
    </cfif>
    </table>
</cfif>
<!--- Documents --->
<cfif Len(Trim(GetDetails.PendencyFileName)) OR
Len(Trim(GetDetails.SettlementFileName)) OR
Len(Trim(GetDetails.ProofFileName)) OR
Len(Trim(GetDetails.MiscFileName))>
    <table width=“100%” cellpadding=“2”
cellspacing=“0” border=“0”>
        <tr><td>&nbsp;</td></tr>
        <tr>
            <td
class=“SectionHeader”><strong>Important Case
Documents:</strong></td>
        </tr>
    <cfif Len(Trim(GetDetails.PendencyFileName))>
        <tr>
            <td class=“DetailItem”><a
target=“_blank”
href=“default.cfm?action=case.viewdocument&CaseID=#URL.
CaseID#&FileType=PEND&FileName=#URLEncodedFormat(GetDetails
.PendencyFileName)#”>Pending</a></td>
        </tr>
    </cfif>
    <cfif Len(Trim(GetDetails.SettlementFileName))>
        <tr>
            <td class=“DetailItem”><a
target=“_blank”
href=“default.cfm?action=case.viewdocument&CaseID=#URL.
CaseID#&FileType=NOT&FileName=#URLEncodedFormat(GetDetails
.SettlementFileName)#”>Settlement Notice</a></td>
        </tr>
    </cfif>
    <cfif Len(Trim(GetDetails.ProofFileName))>
        <tr>
            <td class=“DetailItem”><a
target=“_blank”
href=“default.cfm?action=case.viewdocument&CaseID=#URL.
CaseID#&FileType=POC&FileName=#URLEncodedFormat(GetDetails
.ProofFileName)#”>Proof of Claim</a></td>
        </tr>
    </cfif>
    <cfif Len(Trim(GetDetails.MiscFileName))>
        <tr>
            <td class=“DetailItem”><a
target=“_blank”
href=“default.cfm?action=case.viewdocument&CaseID=#URL.
CaseID#&FileType=MISC&FileName=#URLEncodedFormat(GetDetails
.MiscFileName)#”>Additional Document</a></td>
        </tr>
    </cfif>
    </table>
</cfif>
```

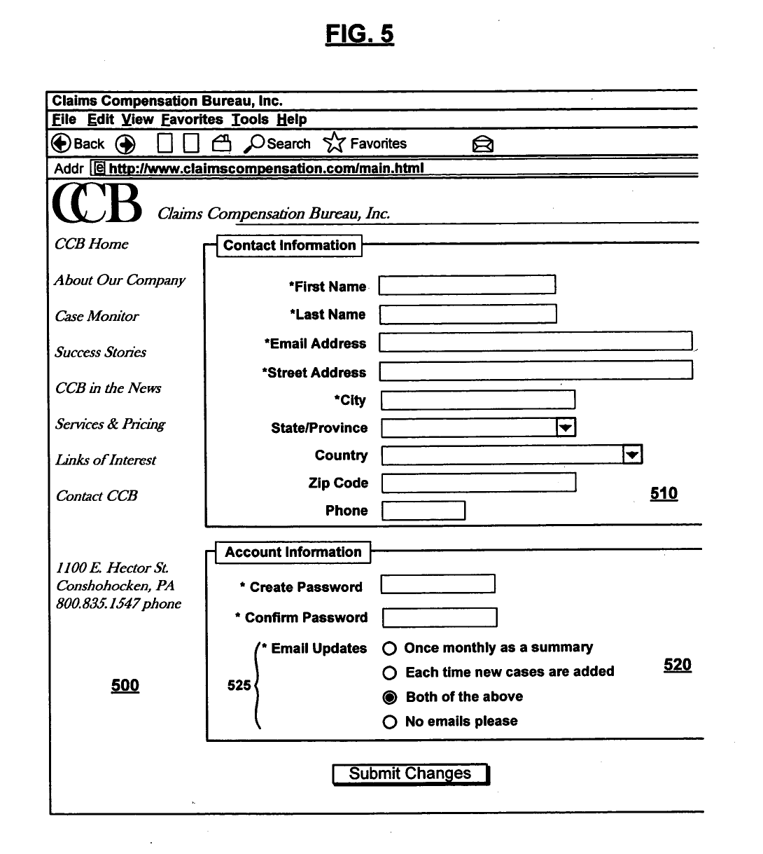

FIG. 5 is a screen shot of an example profile gathering page 500 according to an embodiment of the present invention. The profile is information pertinent to a specific user of the system and includes contact information 510, and account information 520. The account information includes preference items, such as a user selection of emails generated by the system.

For example, email updates 525 allows the user to select email updates that are one of: Once monthly as a summary (Once Monthly), Each time new cases are added (New Cases), Both of the above (Both), and No emails please (None). A selection of Once Monthly programs the system to provide the user with a monthly summary of new cases. A selection of New Cases programs the system to provide the user with a email of new cases as they appear in the system. In one embodiment, the new case emails are timed such that if several new cases are incoming within a predetermined time frame (e.g., over a two day period), an administrator (or automated function in the system) directs that new case emails are held so that each of the incoming new cases within the predetermined time period are sent together (saving the user from getting overloaded with emails). A selection of Both provides both summary and new case emails, and a selection of None excludes the user from the email update sub-system.

Table 3 is an example coding that automatically generates emails utilized in operation of the system. The automatically generated emails include logging in and registration information, new case, and summary emails.

TABLE 3

```
<cfmail to=“#attributes.To#” from=“#attributes.From#”
subject=“#attributes.Subject#” type=“HTML”>
<html>
<style type=“text/css”>
BODY,TD,P {
    font-size: 13px; font-family: Arial,Verdana,sans-
serif;
}
</style>
<body>
<cfif Len(attributes.FirstName)><p>Dear
#attributes.FirstName#</p></cfif>
<cfswitch expression=“#attributes.EmailType#”>
    <cfcase value=“Welcome”>
        <p>Thank you for signing up to receive one
of our class action claims services. We will have one
of our claims experts contact you shortly to discuss
our services in more detail and to answer any questions
you may have. We look forward to having you as a client
and to providing you with the highest level of
service.</p>
        <p>You may now log into the site using your
email address and the following password:
<strong>#FORM.Password#</strong></p>
        <p>After logging in, you can change your
password by clicking the Client Profile link and
editing your account settings.</p>
    </cfcase>
    <cfcase value=“Rejection”>
        <p>Thank you for your interest in our class
action claims services. Unfortunately, we are not able
to offer you this product at the current time. If you
have any questions regarding this decision, please send
a return e-mail.</p>
    </cfcase>
    <cfcase value=“Registration”>
        <p>A user completed the registration form
on #DateFormat(Now( ),“mmmm d, yyyy”)# at
#TimeFormat(Now( ),“h:mm tt”)#, entering the following
information:</p>
        <table width=“100%” cellpadding=“2”
cellspacing=“0” border=“0”>
            <tr>
                <td align=“right”>First
Name:</td>
                <td>#Trim(FORM.FirstName)#</td>
            </tr>
            <tr>
                <td align=“right”>Last
Name:</td>
                <td>#Trim(FORM.LastName)#</td>
            </tr>
            <tr>
                <td align=“right”>Email
Address:</td>
    <td>#Trim(FORM.EmailAddress)#</td>
            </tr>
            <tr>
                <td align=“right”>Street
Address 1:</td>
                <td>#Trim(FORM.Address1)#</td>
            </tr>
            <tr>
                <td align=“right”>Street
Address 2:</td>
                <td>#Trim(FORM.Address2)#</td>
        </tr>
        <tr>
                <td align=“right”>City:</td>
                <td>#Trim(FORM.City)#</td>
            </tr>
            <tr>
                <td
align=“right”>State/Province:</td>
                <td>#Trim(FORM.StateCode)#</td>
            </tr>
            <tr>
                <td align=“right”>Country:</td>
    <td>#Trim(FORM.CountryCode)#</td>
            </tr>
            <tr>
                <td align=“right”>Zip
Code:</td>
                <td>#Trim(FORM.Zip)#</td>
            </tr>
            <tr>
                <td align=“right”>Phone:</td>
                <td>#Trim(FORM.Phone)#</td>
            </tr>
        </table>
    </cfcase>
    <cfcase value=“Monthly”>
        <p>Below is the monthly update of new class
action cases. Click on the case name to go to the
detailed case page for more information on each case.
If you have any questions, please contact one of our
claims experts.</p>
        <p>#attributes.Body#</p>
    </cfcase>
    <cfcase value=“Frequent”>
        <p>Below is your update of new class action
cases. Click on the case name to go to the detailed
case page for more information on each case. If you
have any questions, please contact one of our claims
experts.</p>
        <p>#attributes.Body#</p>
    </cfcase>
</cfswitch>
<cfif attributes.EmailType NEQ “Registration”>
    <p>Sincerely,<br>
    Claims Compensation Bureau<br>
    1100 E. Hector Street, Suite 250<br>
    Conshohocken, PA 19428<br>
    610-834-9010</p>
</cfif>
</body>
</html>
</cfmail>
```

The emails include, for example, direct links to case details for each of the case summaries contained in the emails. The emails are for example, automatically generated and sent upon appropriate triggering conditions related to a users account or activity of cases important to the user. In one embodiment, the emails are automatically prepared, and then approved by an administrator prior to being sent out. In other embodiments, certain emails are automatically generated and sent, while certain other emails (e.g., initial registration) are only sent out after review and approval by an administrator.

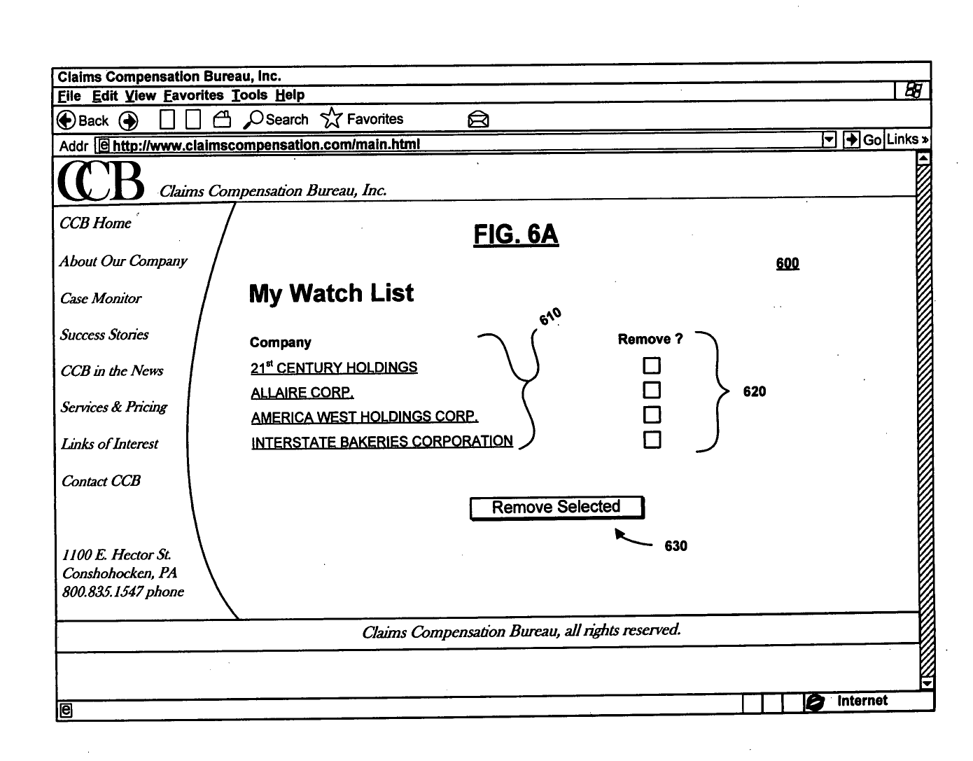

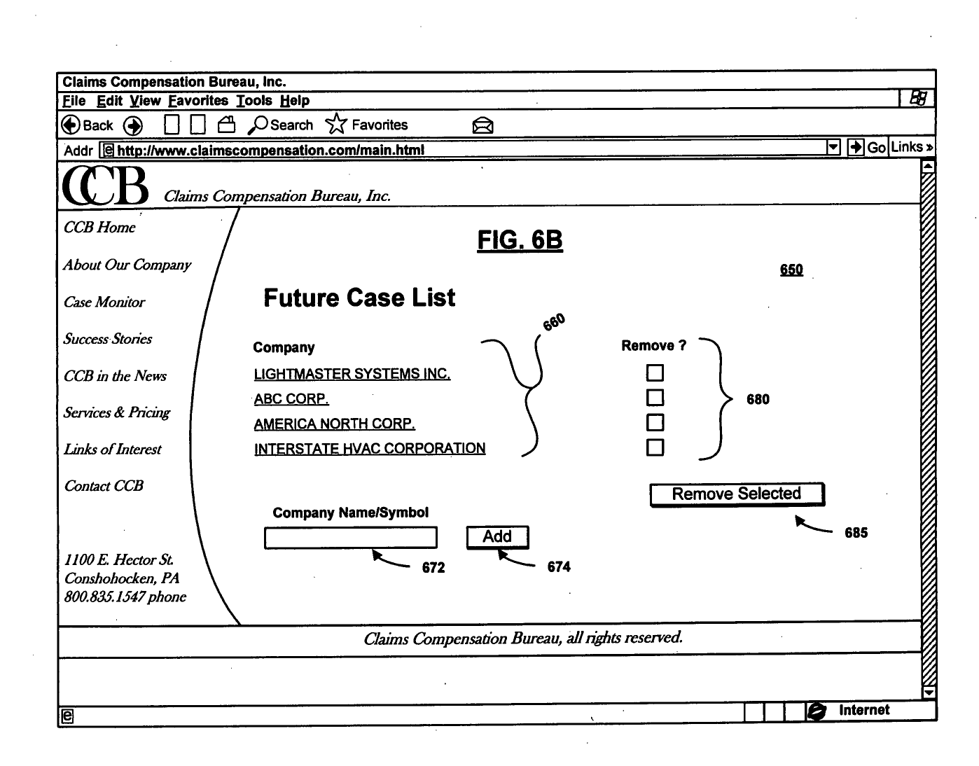

FIG. 6A is a screen shot of an example watch list 600 according to an embodiment of the present invention. The watch list 600 includes a listing of companies 610 and a control checklist 620 (and Remove button 630). Companies are added to the watch list, for example, by invoking an add to watch list button presented, for example, on the detailed case information pages (e.g., FIG. 2, ‘Add to My Watch List’ button 298). Add to watch list may also be performed, for example, by checking an add to watch list check box (e.g., FIG. 2, ‘Watch List’ check boxes 264, FIG. 3 check boxes 364). Monthly updates and new cases emails may also include add to watchlist capabilities. If there is an update to a case watchlist, an email or other alert is sent to the user to bring the change to the user's attention.

The control checklist 620 and remove button 630 allow the user to manage companies on the list by removing individual or a group of selected companies on the watch list. The watchlist includes convenient hyperlinks on each company name to display detailed case information.

In one embodiment, the present invention also includes the provision a Future Case List (e.g., invoked by Future Case List link 135). FIG. 6B is a screen shot of an example Future Case List 650 according to an embodiment of the present invention. The Future Case List 650 is, for example, a list of future cases 660 that includes one or more of company name, stock symbol, and/or other identifying data for which the system reviews and compares against the database. The user is provided facilities to add cases to the future case list, including, for example, a text box 672 for entry of a name or symbol, and an add button 674 and selection boxes 682 and remove button 684.

If a new database entry matches an entry on a user's Future Case List, an email or other alert is sent to the user to bring the new case to the user's attention. Preferably, the user then moves (or enters) the new case to the user's watch list. In one embodiment, cases on a user's future case list are automatically moved to the user's watch list once the case is entered into the database. Other alerts or emails may also be sent to the user at other important points in the case if it remains on the Future Case List after being entered into the database (e.g., when a settlement is reached).

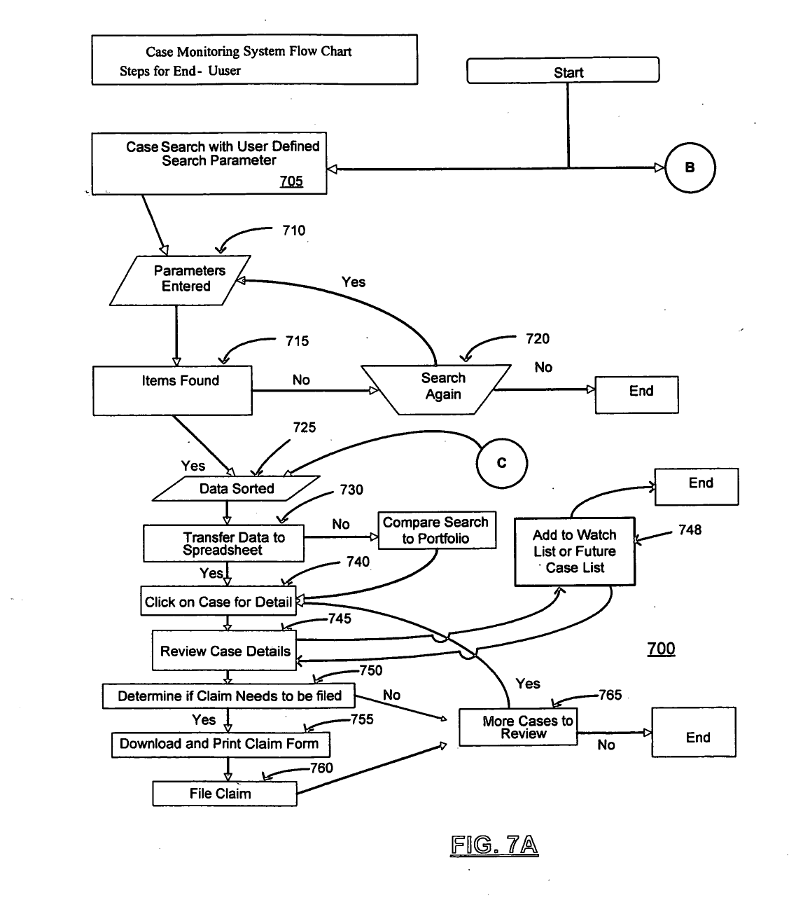

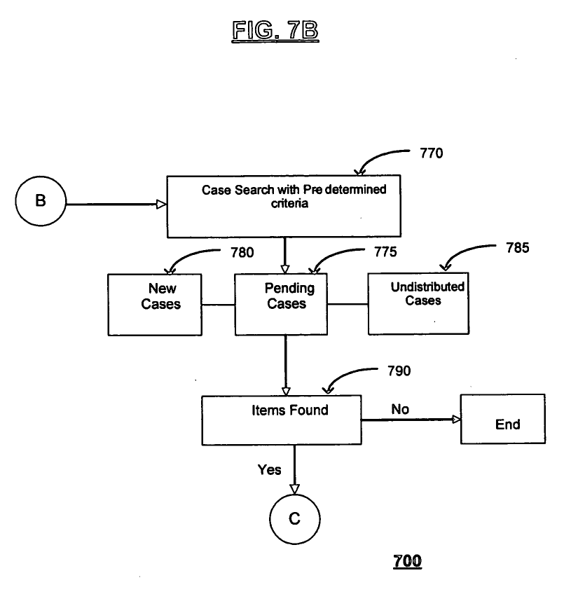

FIGS. 7A, 7B, and 7c, are flow charts of an example user process and interactions 700 with a Case Monitoring System according to an embodiment of the present invention. As shown in the FIG. 7A example, a user may begin interacting with the system via a case search. The user enters parameters for a user defined search 705. The parameters are entered 710, for example, on a search screen similar to that shown in FIG. 2A. If items are found 715 (e.g., cases matching the users search criteria), the items are sorted 725. If no items are found, the user is provided the option to search again 720.

Items found are then transferred, for example, to a spreadsheet style listing 730 (e.g., FIG. 2B) and displayed to the user. The user displays include, for example, clickable column headings so the user can sort the rows of items returned and displayed in the search according to data in any one particular column. At anytime, the user may compare the search results to a portfolio 735.

The user may also click on a specific case to reveal the case details and perform a review 740. Specific case details are reviewed (e.g., step 745), and, if desired, any of the specific cases may be added to either the user's watch list or the Future Case List 748. The user, then, for example, may determine if a claim should be filed for this case by comparing the company, class period, etc. to the user's portfolio 750/735. Each case returned is preferably reviewed by the user 765. In each case where a claim is determined to be filed, the user is, for example, provided a convenient link to forms that can be downloaded/printed 755 and filed with the claims administrator for that case 760.

As shown in FIG. 7B, the user may also interact with the system using predetermined searches 770 (e.g., Pending Cases 775, New Cases 780, and Undistributed Cases 785). The predetermined searches are invoked, for example, via links 122, 124, and 126 as illustrated in FIG. 1. Items returned from the predetermined search are then sorted and reviewed per steps 725-765 as discussed above.

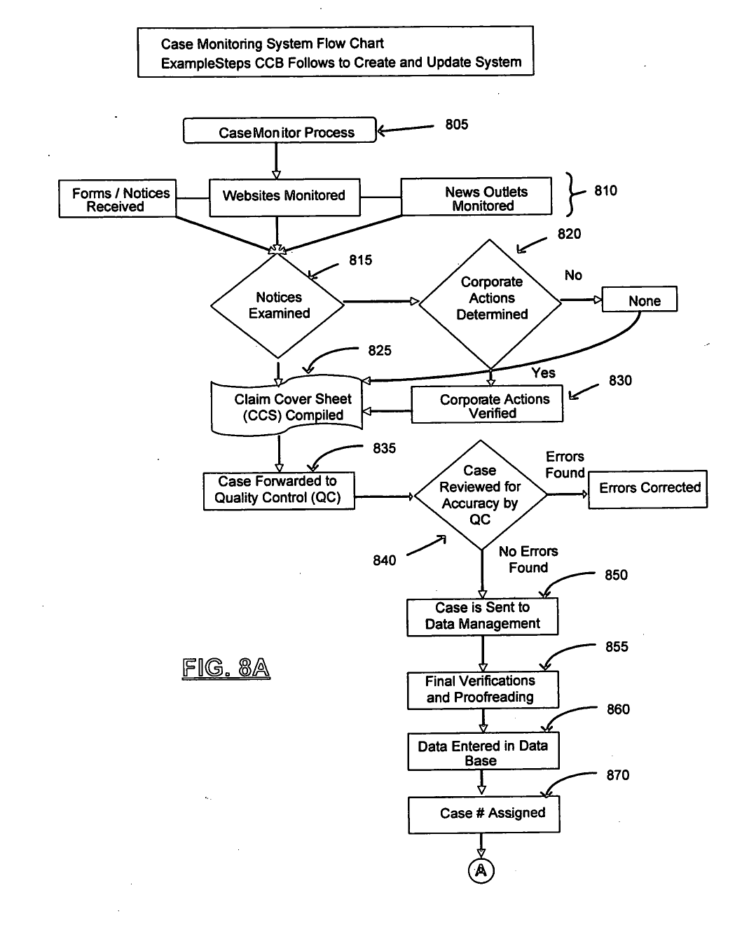

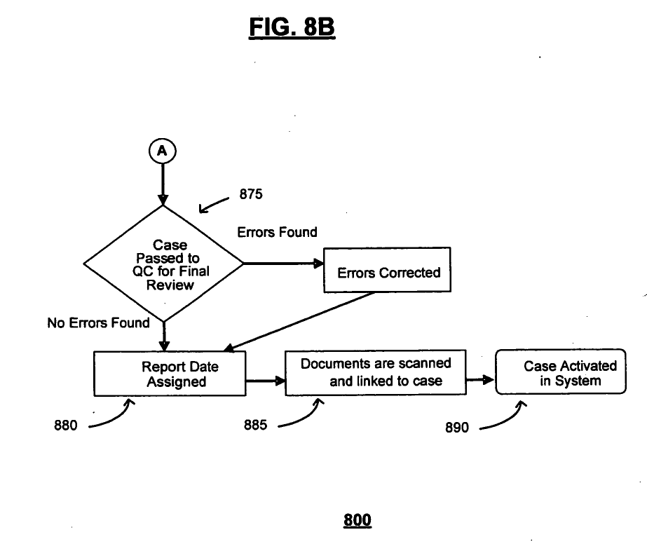

FIGS. 8A and 8B are flow charts 800 of a Case Monitoring System 805 according to an embodiment of the present invention. The case monitor system 805 is performed to bring new data into the Case database. The process begins by viewing data for inclusion in the Case database. The data reviewed includes, for example, Forms and/or notices received from Claims administrators (e.g., court appointed claims administrators), from monitored websites, and monitoring of news outlets 810. The notices or other information is reviewed 815. The review is, for example, a review by an experienced case manager. The review includes a determination of corporate actions 820 which are then verified 830. A corporate action is, for example a stock symbol change, stock split, company merger or acquisition which is then verified via alternative sources.

A claims cover sheet (CCS) is compiled 835 for each new case which is then forwarded and reviewed by Quality Control (QC) 835/840. The QC review is, for example, a senior case manager that directs correction of errors, if any. The QC'd case is then sent to Data Management 850 and final proofreading and verifications 855 are performed. A case is assigned a unique number and the case is entered into the case database 860/870.

As shown in FIG. 8B, upon entering the case database, the case is again reviewed by QC for a final review and errors or preferential items are corrected and finalized. Thus, in at least one embodiment, the present invention includes a multi-level review of case information derived and quality controlled from multiple sources. A report date is then assigned 880, documents are scanned and linked to the case 885, and the case is then activated in the system 890.

In one embodiment, as generally described above with reference to the figures, the monitoring performed by the present invention includes all of the following:

1. Daily Case Monitoring by Research Department
a) New cases from various claims administrators are received via mail.
b) All administrator websites are checked for new case listings.
c) Major financial publications are monitored for new case announcements and updates on existing cases.
d) Numerous business/financial websites are monitored for new case announcements and updates on existing cases.

2. Monthly Case Monitoring by Research Department
a) All claims administrator websites are checked for new case listings.
b) Settled case listings are checked on various additional sites.
c) SEC website is checked for new SEC enforcement cases.

3. New Case Processing & Completion of Case Cover Sheet by Research Dept.
a) Claim notices are examined for the following general information, highlighting in yellow.
   Company Name
   Class Period
   Filing Deadline
   Opt-Out/Exclusion Deadline
   Settlement Fund
   Claims Administrator
   Case Status
b) Find and confirm security symbols and CUSIP numbers through various websites.
c) The following corporate actions are researched online where warranted.
   Mergers
   Acquisitions
   Stock Splits
   Symbol Changes
d) In conjunction with the Research Department's corporate action analysis, the Data Management Department will be asked to more thoroughly check and confirm corporate action information through the SEC website.
e) More detailed aspects of each case are analyzed to determine the following. This information will assist claim filers in completely and accurately completing their claim.
   Is option trading included in the claim calculation?
   Are option premiums included in the claim calculation?
   Is this case part of a supplemental settlement?
   Are there multiple sub-periods in the plan of allocation?
   Is the plan of allocation calculated on a LIFO (last-in-first-out) basis?
   Is there a table involved in the plan of allocation?
   Are gains ignored in the claim calculation?
   Are recoveries for option trading limited?
   Are short sales and covering purchases included in the claim calculation?
   Miscellaneous claim filing information/tips are noted. This information would be anything not covered above that would be useful information for those calculating and filing a claim.
f) The Case Cover Sheet is filled in with the information gathered above.
g) The Case Cover Sheet, claim notice, claim form, and other pertinent claim documents are passed to the Quality Control Department.

4. Quality Control & Data Management
a) The Case Cover Sheet and accompanying information are reviewed by quality control to make certain all details are correctly and completely filled in.
b) Any corrections and additions are made on the Case Cover Sheet.
c) The Case Cover Sheet and accompanying information are passed to the Data Management Dept.
d) Case is searched in database to determine that it is indeed a new case. If the case appears to be a previously entered case, the class periods and filing deadlines are compared to avoid duplicate entry.
e) CUSIPS and stock symbols are verified. Comment section is proofread.
f) Data management carefully inputs all the information from the Case Cover Sheet into CCB's case monitoring database.
g) A case number is assigned.
h) The case is kept inactive on the system.
i) The Case Cover Sheet and accompanying information are passed back to quality control.
j) Quality control checks the entry in the monitoring system against the information on the Case Cover Sheet.
k) Any corrections are made in the system by quality control.
l) The Report Date (current date) is entered on the Case Cover Sheet and monitoring system by quality control.
m) The Case Cover Sheet is initialed by quality control to record the final quality check.
n) Quality control activates the case on the monitoring system unless documents need to be scanned and attached to the entry.
o) Any necessary notice and claim form scanning is done by the Document Processing Dept.
p) Data management is informed by document processing once necessary files are scanned.
q) Data management attaches scanned files and activates case.
r) Data management files Case Cover Sheet and case information.

In one embodiment, the present invention includes claim form pre-populating. For example, when a user downloads a claim form, it is, for example, pre-populated with client id information in the appropriate fields. Expert analysis of the claim form includes identifying which client fields from a database of client information are to be used to pre-populate fields of the claim form. The client then downloads or prints the claim form and completes any remaining fields prior to submitting the claim form with the claims administrator. In other embodiments, stock information is retrieved from the client (e.g., from a related account or other database), and additional fields, including stock information is pre-populated as appropriate for the claim form.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing a web interface for retrieving data or format for display of case information, any number of other formats or retrieval mechanisms may be utilized, or other device having an equivalent function or capability, whether or not listed herein, may be substituted therewith. Furthermore, the inventors recognize that newly developed technologies not now known may also be substituted for the described parts and still not depart from the scope of the present invention. All other described items, including, but not limited to databases, displays, web pages, processes, reviews, links, automated emails, email contents, customers, data structures, sources, strategies, and other parts of the present invention, etc should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CDRW+/−, micro-drive, and magneto-optical disks, ROMs, RAMs, EPROMs, EEPROMs, DRAMs, VRAMs, flash memory devices (including flash cards, memory sticks), magnetic or optical cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, identification and retrieval of case information, checking case items, retrieving user information, database queries, database updates, logging transactions, monitoring database entries, production of emails and managing automated emails, etc., and the display, storage, or communication of results according to the processes of the present invention.

The present invention may suitably comprise, consist of, or consist essentially of, any of element (the various parts or features of the invention) and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

What is claimed and Desired to be Secured by Letters Patent of the United States is:

1. A method, comprising the steps of:
preparing a database of information for each of a plurality of class action cases pending and/or settled against a set of companies;
querying the database and retrieving results of the query; and
displaying the results of the query.

2. The method according to claim 1, wherein the database contains information comprising expert analysis of a claim notice for cases having claim forms available.

3. The method according to claim 1, wherein the displayed results include at least one field comprising information derived from expert analysis of a plan of allocation.

4. The method according to claim 3, wherein the expert analysis provides each of, Company Name, Class Period, Filing Deadline, Opt-Out/Exclusion Deadline, Settlement Fund, Claims Administrator, and Case Status.

5. The method according to claim 1, wherein the database of information comprises a series of cases, each case comprising a company and a set of information regarding class action(s) pending and/or settled against the company.

6. The method according to claim 5, wherein the set of information comprises data obtained from multiple sources not readily available on a claim notice, such as corporate actions.

7. The method according to claim 6, wherein the corporate actions includes each of Mergers, Acquisitions, Stock Splits, and Symbol Changes where applicable for a particular case.

8. The method according to claim 1, wherein the set of companies comprises a set of publicly traded companies.

9. The method according to claim 1, wherein the query is a set of companies; wherein the query is a set of actions.

10. The method according to claim 1, wherein the step of utilizing the results comprises automatically preparing at least part of a claim form for one of the query results.

11. The method according to claim 10, wherein the step of automatically preparing comprises automatically pre-populating fields of the claim form.

12. The method according to claim 11, wherein the pre-populated fields comprise at least client ID information.

13. The method according to claim 11, wherein the pre-populated fields comprise at least client ID information and stock data.

14. The method according to claim 1, wherein the step of preparing a database comprises the step of scanning multiple sources for case information and inputting individual case data into the database.

15. The method according to claim 11, wherein the multiple sources comprise notices received, websites, and news outlets.

16. The method according to claim 1, wherein the step of querying comprises invoking a link to a predetermined database query.

17. The method according to claim 16, wherein the predetermined query is one of new cases, undistributed cases, and pending cases.

18. The method according to claim 1, wherein the step of querying comprises building a specific database query based on criteria selected by a user.

19. The method according to claim 1, further comprising the step of utilizing the results in the preparation of a claim form.

20. The method according to claim 1, wherein the displayed results comprise a spreadsheet style listing of high level information about each case in the results.

21. The method according to claim 20, wherein each case includes a hyperlink to detailed information about the case.

22. The method according to claim 21, wherein the hyperlink is placed on one of a company name or stock symbol of the case.

23. The method according to claim 14, wherein the detailed information comprises at least one of specific information derived from a plan of allocation and forms for the case.

24. A method of administering a Claims Compensation business, comprising the steps of:
registering a set of users;
receiving a watch list from each user;
periodically querying a claims database;
comparing case results from the query to each user's watch list;
comparing case results from the query to each user's future case list;
notifying a user if any of the case results comprise either new cases or settled cases matching any part of the user's watch list or future case list.

25. The method according to claim 24, wherein the steps of registering and receiving are performed on registration and portfolio selection pages of a web site.

26. The method according to claim 25, wherein the web site is a claims compensation web site.

27. The method according to claim 24, further comprising the step of receiving a future case list from each user.

28. The method according to claim 24, wherein the watch list comprises a plurality of individual stocks and/or bonds and the user is a legally responsible individual for filing claims.

29. The method according to claim 24, wherein the step of notifying comprises sending an email to the user including a web based link to further information about the matched cases.

30. The method according to claim 29, wherein the email is sent at predetermined intervals.

31. The method according to claim 30, wherein the predetermined intervals comprises at least one of as updates occur and on a scheduled periodic basis.

32. The method according to claim 24, wherein the notification is performed if the user has not been previously notified of the matching case.

33. The method according to claim 24, wherein:
said method is embodied in a set of computer instructions stored on a computer readable media;
said computer instructions, when loaded into a computer, cause the computer to perform the steps of said method.

34. The method according to claim 24, wherein portions of the method are performed on a web server interacting with the users over the Internet
